(19) United States
(12) Patent Application Publication
(10) Pub. No.: US 2002/0166418 A1
(43) Pub. Date: Nov. 14, 2002

(54) Wrench capable of avoiding detachment of a screw-thread member

(76) Inventor: Shih Kuei Hsieh, Taichung (TW)

Correspondence Address: DOUGHERTY & TROXELL, ONE SKYLINE PLACE, SUITE 1404, 5205 LEESBURG PIKE, FALLS CHURCH, VA, 22041, US

(21) Appl. No.: 09/852,642

(22) Filed: May 11, 2001

(51) Int. Cl. B25B 13/02

(52) U.S. Cl. 81/125

(57) ABSTRACT

Wrench capable of avoiding detachment of a screw-thread member. The wrench is used to fit onto a polygonal screw-thread member, including: a handle section; a head section disposed at one end of the handle section and formed with a polygonal fitting hole; at least one channel formed on the inner circumference of the fitting hole along the axis of the fitting hole; and at least one slide member up and down movably disposed in the channel and partially protruding into the fitting hole, the sliding travel of the slide member having an upper and a lower dead ends. The wrench can be fitted onto the screw-thread member from both ends of the fitting hole and the slide member can be pushed by the screw-thread member and moved to any of the dead ends and stopped thereby. The screw-thread member is stopped by the slide member from slipping out of the wrench.

### BACKGROUND OF THE INVENTION

The present invention is related to a hand tool, and more particularly to a wrench having restricting effect for avoiding detachment of a screw-thread member from the wrench. The wrench can be fitted onto the screw-thread member from both front face and back face to prevent the screw-thread member from slipping out of the wrench.

A conventional wrench is used to wrench a screw-thread member such as a nut or a bolt. The wrench generally has a socket in which the screw-thread member is fitted. In operation, the screw-thread member tends to detach from the wrench. This leads to inconvenience in operation. In order to solve this problem, wrenches with restricting structures have been developed to prevent the wrench from detaching from the nut or bolt.

FIG. 1 shows a conventional wrench 10 having a handle 11 on which a slide collar 12 is fitted. When a tongue section 121 of the slide collar 12 is moved to the socket 14 of the wrench, the nut is stopped from slipping out of the socket 14.

FIG. 2 shows another type of wrench 15 having a head section 16. Three pin members 17 are radially passed through the head section 16 to protrude into the socket 18. As shown in FIG. 3, when the wrench 15 is fitted onto the nut, the nut 19 is stopped by the pin members 17 from slipping out of the socket.

In FIG. 4, the wrench 20 has a multiangular socket 21. A projecting section 23 inward projects from top edge of each reentrant angle 22. As shown in FIG. 5, when the wrench is fitted onto a nut 24, the projecting sections 23 serve to stop the nut.

In FIG. 6, an inlay channel 27 is formed on the top face of the head section 26 of the wrench 25. A ring member 28 is provided with two lugs 281 inlaid in the inlay channel 27. The ring member 28 protrudes from the reentrant angle 291 of the socket 29 for stopping the nut.

In FIG. 7, a ring member 32 is inlaid in the head section 31 of the wrench 30. The ring member 32 protrudes from the reentrant angle 331 of the socket 33 for stopping the nut.

FIG. 8 shows a ratchet wrench 35 having a ratchet 36. One side of the ratchet 36 is integrally formed with an inward extending flange 38 for stopping the nut.

All the above restricting structures also restrict the operation of the wrenches. That is, the socket can be only fitted onto the nut from the open end (front face) and it is impossible to fit the wrench onto the nut from the close end (back face with the restricting structure). This leads to inconvenience in use.

### SUMMARY OF THE INVENTION

It is therefore a primary object of the present invention to provide a wrench capable of avoiding detachment of a screw-thread member from the wrench. The wrench has a restricting structure, while being still able to fit onto the screw-thread member from both front face and back face to prevent the screw-thread member from slipping out of the wrench.

The present invention can be best understood through the following description and accompanying drawings wherein:

### BRIEF DESCRIPTION OF THE DRAWINGS

FIG. 1 is a top view of a part of a conventional wrench;

FIG. 2 is a perspective view of another type of conventional wrench;

FIG. 3 shows the use of the wrench of FIG. 2;

FIG. 4 is a perspective view of still another type of conventional wrench;

FIG. 5 shows the use of the wrench of FIG. 4;

FIG. 6 is a perspective exploded view of still another type of conventional wrench;

FIG. 7 is a perspective exploded view of still another type of conventional wrench;

FIG. 8 is a perspective view of still another type of conventional wrench;

FIG. 9 is a perspective view of a preferred embodiment of the present invention;

FIG. 10 is a cross-sectional view of the wrench of FIG. 9;

FIG. 11 is a longitudinal sectional view of the wrench of FIG. 9;

FIG. 12 is a top view showing that the wrench of FIG. 9 is fitted onto a nut from front face;

FIG. 13 is a sectional view according to FIG. 12;

FIG. 14 is a sectional view according to FIG. 13, showing that the wrench of FIG. 9 is fitted onto the nut from back face;

FIG. 15 is a top view of another embodiment of the present invention;

FIG. 16 is a top view of still another embodiment of the present invention;

FIG. 17 is a sectional view according to FIG. 16, showing that the portion of the fitting hole free from the restricting member is fitted onto the nut;

FIG. 18 is a perspective view of still another embodiment of the present invention; and

FIG. 19 is a perspective view of still another embodiment of the present invention.

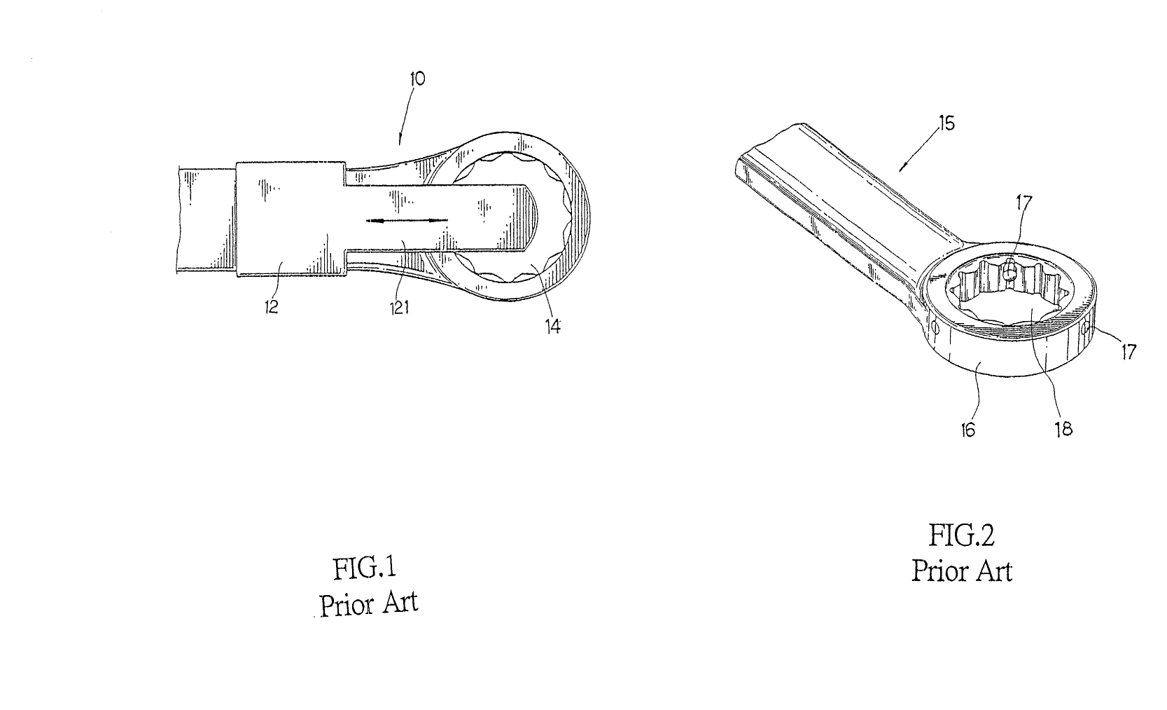

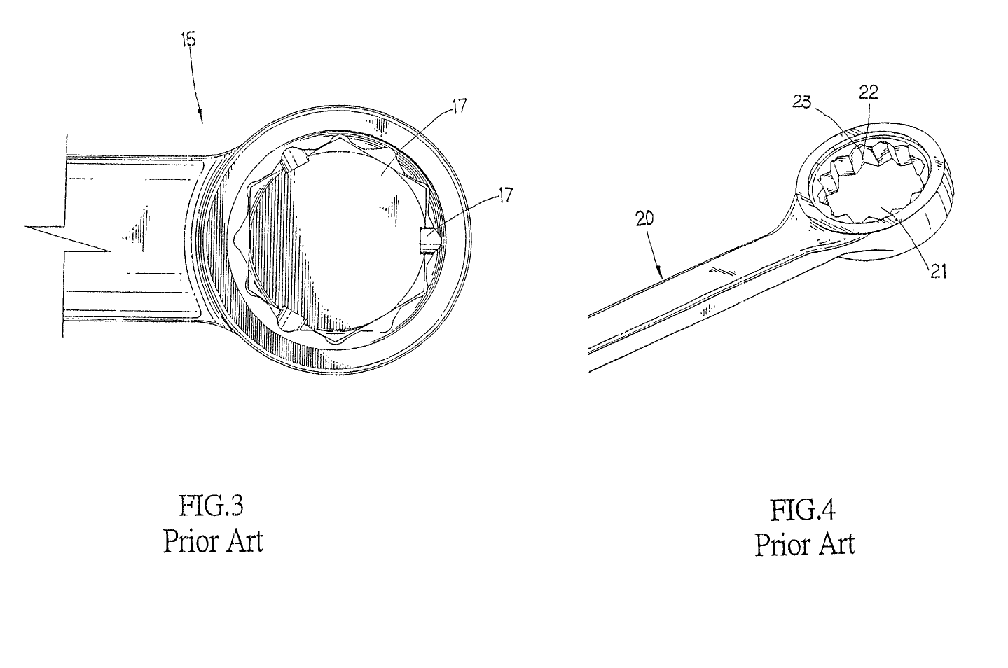

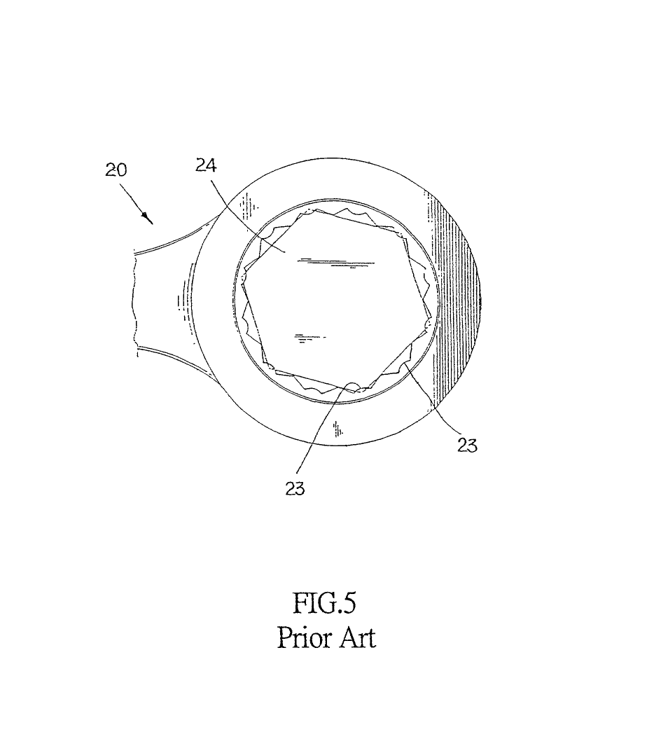

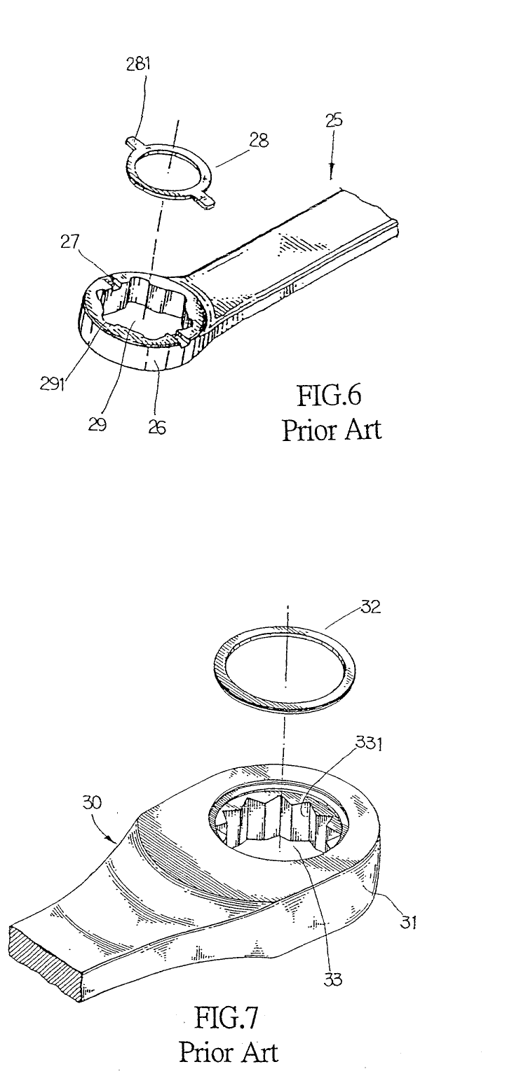

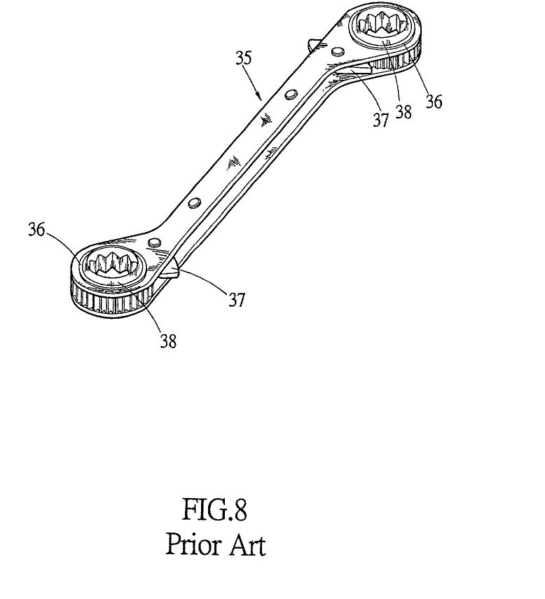

### DETAILED DESCRIPTION OF THE PREFERRED EMBODIMENTS

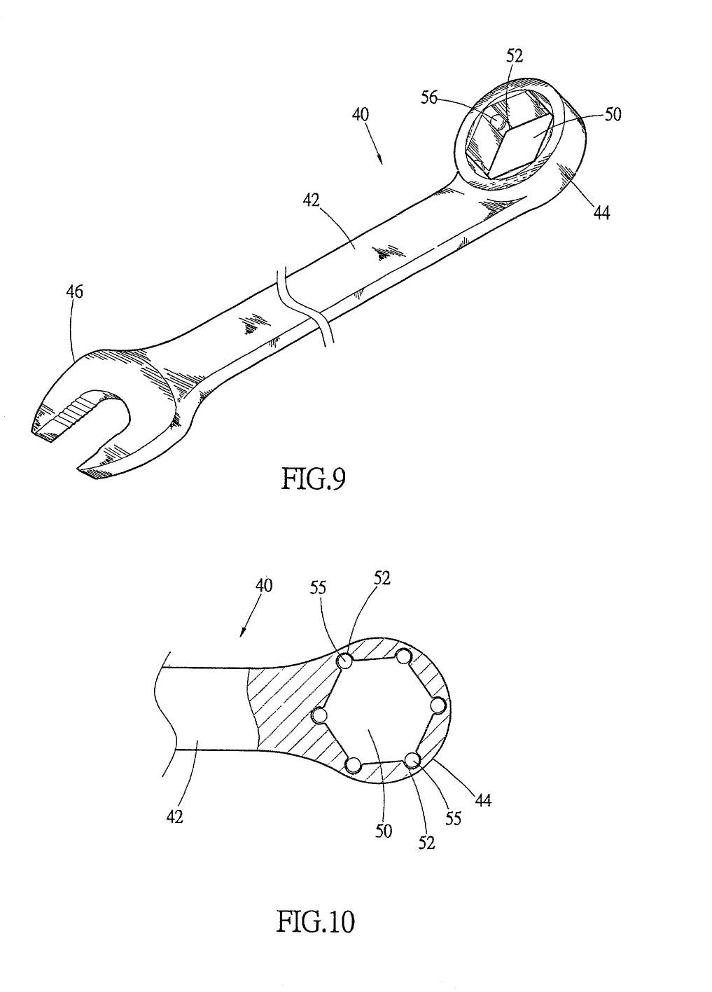

Please refer to FIGS. 9, 10 and 11. According to a first embodiment, the wrench 40 of the present invention has a handle section 42 and a head section 44 and an open end 46 respectively formed at two ends of the handle section 42.

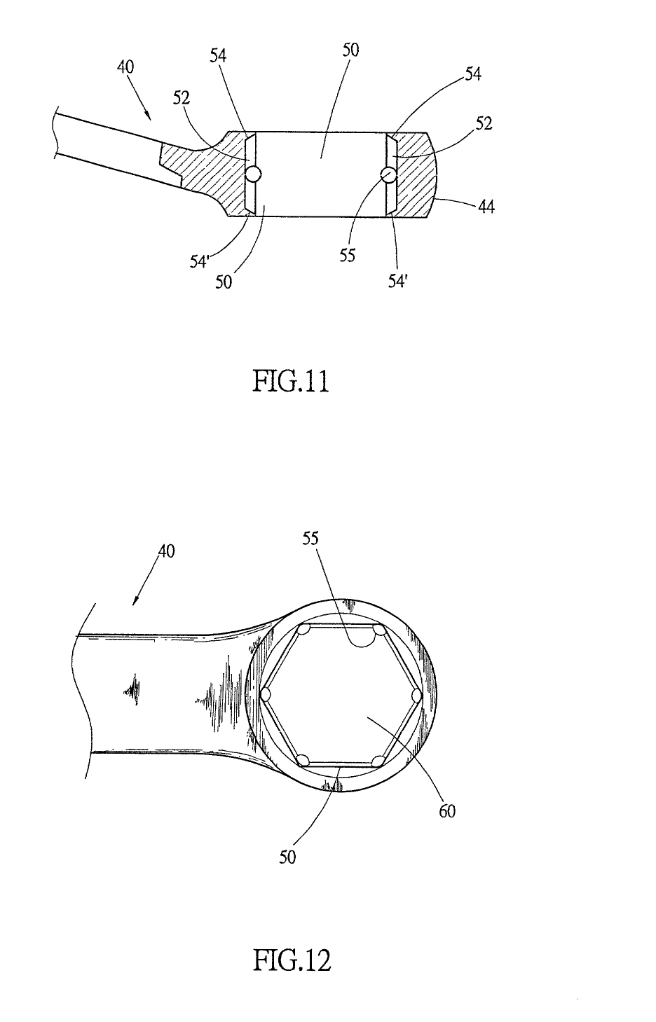

The head section 44 is formed with a hexagonal fitting through hole 50. The inner circumference of the fitting hole 50 is formed with six reentrant angles and six sides. Each reentrant angle is formed with a channel along the axis of the fitting hole. The channel communicates with the fitting hole. As shown in FIG. 10, the channel 52 has a cross-section with wider interior and narrower opening. The top and bottom ends of the channel 52 are respectively provided with two stop sections 54, 54′ as shown in FIG. 11.

Six restricting members 55 are received in the channels 52 and up and down slidable along the channels 52. In this embodiment, the restricting members 55 are steel balls. The restricting member partially protrudes from the opening of the channel into the fitting hole 50. The opening of the channel has a narrower width so that the restricting member 55 is prevented from dropping out of the channel. In addition, the upper and lower stop sections 54, 54′ of the channel serve as upper and lower dead ends of the sliding of the restricting member.

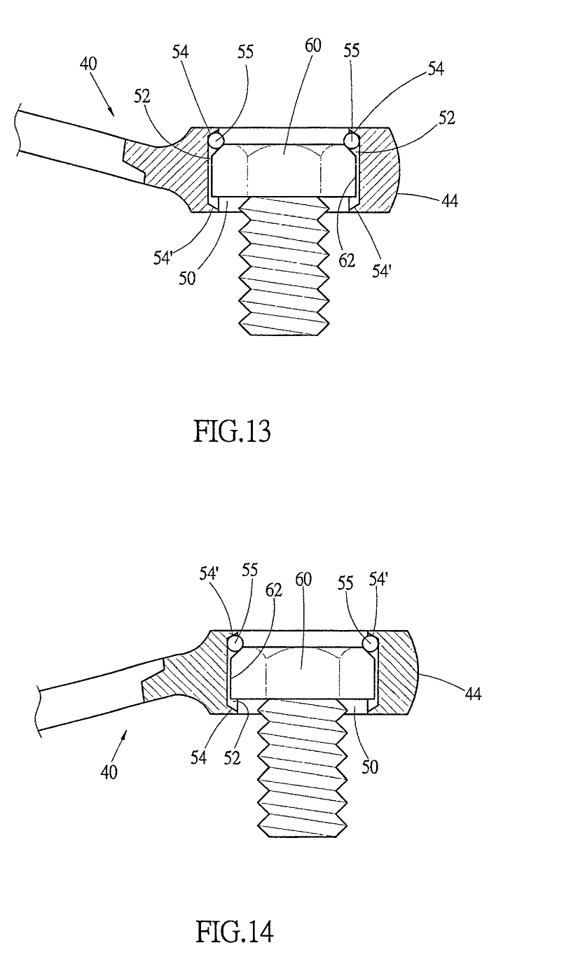

When using the wrench 40 from front face thereof as shown in FIGS. 12 and 13, the fitting hole 50 is downward fitted onto a nut or a bolt 60 with the angles 62 of the bolt aimed at the reentrant angles of the fitting hole. At this time, the angles 62 of the bolt will touch the restricting members 55. When the bolt 60 is slided into the fitting hole 50, the restricting members 55 are pushed by the bolt and upward moved along the channels 52. After the restricting members 55 are moved to the upper stop sections 54 and stopped thereby, the bolt is stopped and located by the restricting members 55 without departing from the wrench.

Alternatively, the wrench 40 can be fitted onto the bolt from back face of the fitting hole as shown in FIG. 14. Under such circumstance, the upper stop section 54 is positioned on lower side, while the lower stop section 54′ is positioned on upper side. The restricting members 55 are pushed by the bolt 60 and moved within the channels 52. After the restricting members 55 are moved to the lower stop sections 54′ and stopped thereby, the bolt is stopped by the restricting members 55 and prevented from departing from the wrench.

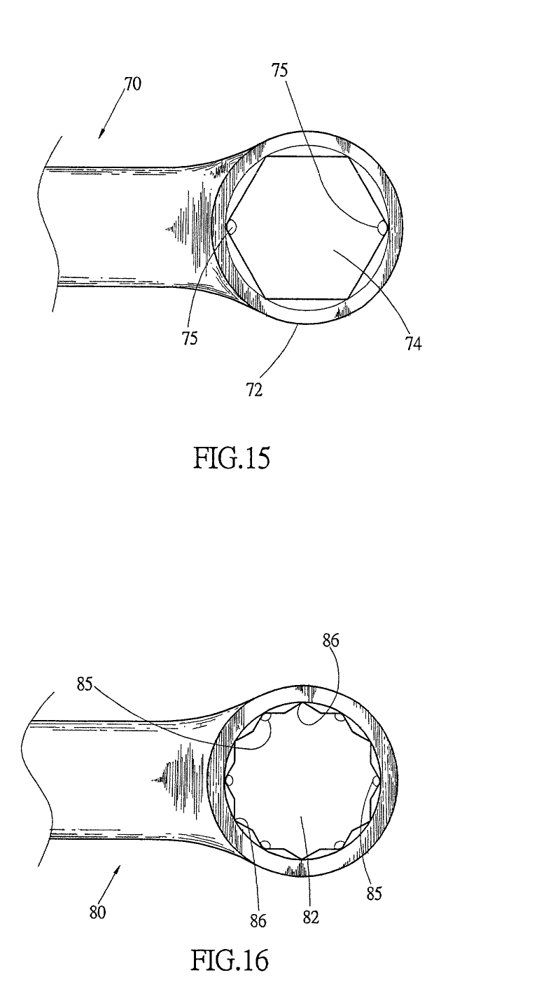

FIG. 15 is a top view showing another preferred embodiment of the present invention. The head section 72 of the wrench 70 is formed with a hexagonal fitting hole 74. Only two reentrant angles of the fitting hole 74 are provided with channels in which two restricting members 75 are respectively slidably received. The wrench can be fitted onto a bolt from front or back face to achieve the same effect as shown by FIGS. 13 and 14.

FIG. 16 shows still another preferred embodiment of the present invention. The fitting hole 82 of the wrench 80 is dodecagonal and has two sets of concentric hexagonal fitting positions. Six reentrant angles of the first set of fitting position are provided with channels in each of which a restricting member 85 is received, while the six reentrant angles 86 of the second set of fitting position are free from the restricting member.

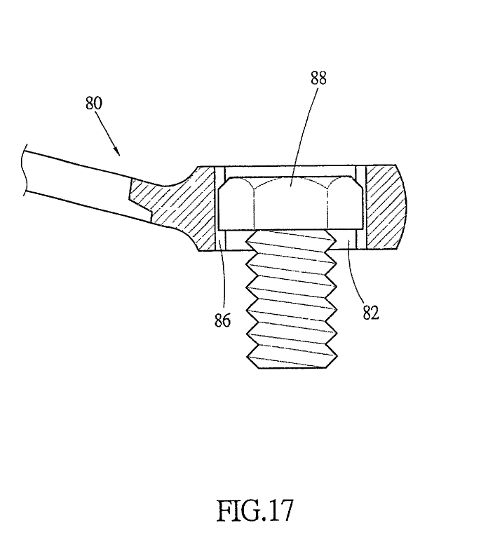

When the first set of fitting position provided with the restricting members 85 of the wrench 80 is fitted onto the bolt, the bolt is stopped as shown in FIGS. 13 and 14. Alternatively, when the second set of fitting position free from the restricting member 85 is fitted onto the bolt as shown in FIG. 17, the bolt is not restricted by six reentrant angles 86 and can be freely moved up and down within the second set of fitting position.

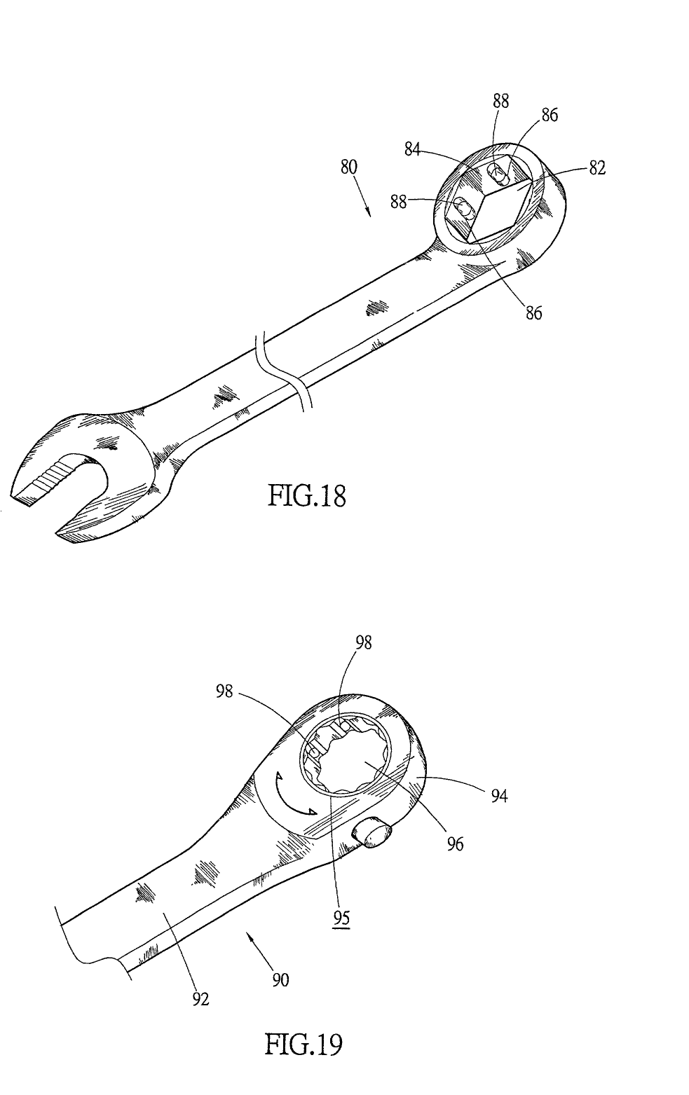

FIG. 18 shows still another preferred embodiment of the present invention, in which the sides 84 of the fitting hole 82 are formed with several channels 86 in which several restricting members 88 are respectively up and down movably received. Similarly, the restricting members protrude into the fitting hole without dropping out. When the wrench 80 is fitted onto the bolt, the sides of the bolt are stopped by the restricting members 88. Accordingly, the wrench 80 can be fitted onto the bolt from both front and back faces to achieve a stopping effect for the bolt.

The above wrenches of the respective embodiments are all fixed-type wrenches without ratchet. However, the structure of the present invention is applicable to various kinds of ratchet wrenches.

FIG. 19 shows still another embodiment of the present invention, in which the wrench 90 is a ratchet wrench having a handle section 92 and a head section 94 disposed at one end of the handle section. A rotatable ratchet 95 is mounted in the head section. The ratchet 95 has a multiangular fitting hole 96 for fitting with a bolt. The ratchet is deterred by a detent assembly (not shown) disposed in the head section to achieve a ratchet effect. Several restricting members 98 are up and down movably disposed in the fitting hole 96. Accordingly, the ratchet wrench can be fitted onto the bolt from both front and back faces to prevent the bolt from detaching from the wrench.

The above structures of FIGS. 9 to 18 can be all mounted in various kinds of ratchet wrenches.

The above embodiments are only used to illustrate the present invention, not intended to limit the scope thereof.

What is claimed is:

1. Wrench capable of avoiding detachment of a screw-thread member, said wrench being used to fit onto a polygonal screw-thread member such as a nut or a bolt, comprising:
a handle section;
a head section disposed at one end of the handle section, the head section being formed with a polygonal fitting through hole for fitting onto a screw-thread member, the inner circumference of the fitting hole being formed with multiple reentrant angles and sides;
at least one channel formed on the inner circumference of the fitting hole along the axis of the fitting hole; and
at least one slide member up and down movably disposed in the channel without dropping out of the channel, the slide member protruding from the channel into the fitting hole, the sliding travel of the slide member within the channel having an upper and a lower dead ends, whereby the wrench can be fitted onto the screw-thread member from both ends of the fitting hole and the slide member can be pushed by the screw-thread member and moved to any of the dead ends and stopped thereby.

2. Wrench as claimed in claim 1, wherein the channel is formed at a reentrant angle of the fitting hole.

3. Wrench as claimed in claim 1, wherein the channel is formed on a side of the fitting hole.

4. Wrench as claimed in claim 1, wherein the top and bottom ends of the channel are respectively provided with two stop sections, whereby when the slide member moves within the channel, the stop sections stop the slide member and serve as the dead ends of the travel thereof.

5. Wrench as claimed in claim 1, wherein the channel has a wider interior and a narrower opening, whereby the slide member is received in the channel without dropping out.

6. Wrench as claimed in claim 1, wherein the slide member is a ball body.
